(19) United States
(12) Patent Application Publication
(10) Pub. No.: US 2008/0315049 A1
(43) Pub. Date: Dec. 25, 2008

(54) Mounting System for a Household Appliance

(75) Inventors: Elio Bailo, Stenico (Trento) (IT); Enrico Omezzolli, Nago-Trento (IT)

Correspondence Address: SHOEMAKER AND MATTARE, LTD, 10 POST OFFICE ROAD - SUITE 110, SILVER SPRING, MD, 20910, US

(73) Assignee: OMB S.R.L., Stenico (IT)

(21) Appl. No.: 11/816,962

(22) PCT Filed: Mar. 10, 2006
(86) PCT No.: PCT/IT06/00144

§ 371 Date: Sep. 19, 2007

(30) Foreign Application Priority Data
Mar. 11, 2005 (IT) BS2005 A 000031
Jun. 14, 2005 (IT) VR2005 A 000079

(51) Int. Cl. F16M 11/10

(52) U.S. Cl. 248/176.1

(57) ABSTRACT

A mounting system for supporting a household appliance such as a monitor includes a support element which can be removably connected to the appliance and an anchoring element for fixing the mounting system to a support interface. The support pivots on an axis so that the appliance can oscillate.

The present invention relates to a mounting system, hereinafter also referred to as support structure, particularly but not exclusively for television sets but also for household appliances in general.

It is a further object of the present invention a mounting system for a device, such as a television screen, a monitor, a CRT monitor, an LCD monitor, a flat screen and the like.

The mounting system, in particular, is a tilting mounting and support system for angularly orientating the device as desired.

Known mounting systems for a device that allow tilting and positioning a device in a steady balanced position exhibit two brackets, turnably associated, wherein one of the two brackets exhibits arched grooves inside which there slide two pins or “sliding blocks”, for allowing the device oscillating movement about the centre of rotation defined by the arched grooves and wherein there are locking means for fixing the device in a steady position, at the desired tilt.

Examples of tilting mounting and support systems for screens and displays are, for example, described in document WO2004063619 and in document US20040245420.

However, in order to be adjusted, such supports require a single operator to intervene to remove the device from the support and then manually adjust the tilt by acting on the locking means and on the supports, or two operators to intervene at the same time, one of which acting on the locking means, loosening them, adjusting the desired tilt and then closing the locking means again, while the other one sustains the device so as to prevent it from suddenly sliding during the operation for adjusting the position thereof, for example in the case of an accidental knock.

On the market there are also further different types of support structures used for fixing television sets, especially with flat screen, to the walls.

Such structures generally consist of an anchoring element, fixable to the wall, and of an element for supporting the television set; in order to allow the suitable orientation of the television set there are usually provided means for adjusting the tilt of the support element relative to the anchoring element and thus, relative to the wall.

Typically, the support element is turnably supported to the anchoring element about an oscillation axis (generally a horizontal axis parallel to the wall itself) whereas various types of locking devices act for locking the support element to the desired position.

Among the support structures, in particular, the so-called “continuous adjustment” ones are known, wherein on one of the two elements there is provided a circular development groove whereas on the other one there is provided a pin sliding into the groove and lockable, by the use of various devices, along such groove. Examples of such structures are described, for example, in the U.S.A. ornamental model No. US D 494,596 S by Pfister or in the Japanese patent application No. 11330547 by Fujitsu General Ltd.

Alternatively, always among continuous adjustment structures, some of them exist which exhibit, at the support element, one or more rectilinear slits which are slidingly engaged by a pin mounted on a respective connecting rod turnably coupled to the anchoring element; also these types of structures, of course, must be associated to relative locking means between the two elements. Among the various support structures exhibiting such gears we may mention those described in U.S. Pat. No. 6,402,109 by Dittmer and U.S. Pat. No. 6,604,722 by Tan.

Support structures are further known, wherein it is possible to adjust in a “discrete” manner the tilt between the two elements by using a kinematic connection similar to that described and illustrated in the U.S.A. patent application No. U5 2002/0033436 A1 by Peng et al.

All the structures described above, despite being valid from a conceptual point of view, exhibit the disadvantage of forcing the user, if he/she wants to change the relative tilt between the anchoring element and the support one, to release the relative locking means and at the same time move the television set, or the support element, to move it to the selected position to lock the locking means again. If the concurrent performance of these two operations is in any case possible, though difficult, in the case of small-sized television sets, if the support structure is associated to television sets (or to objects in general) of large size and weight, this is virtually impossible with the consequence that two people are required to change the tilt of the object supported, in practice: one that releases (and then re-locks) the locking means between the support element and the anchoring element, and a second person that changes the relative tilt (by moving the supported object or, directly, the support element itself).

The object of the present invention is to provide a mounting system for a device, such as a television screen, a monitor, a CRT monitor, an LCD monitor, a flat screen and the like, which should overcome the disadvantages mentioned with reference to the prior art.

Moreover, a main task of the present invention is to eliminate or at least drastically reduce the disadvantages mentioned above in known types of support structures, particularly but not exclusively for television sets.

In particular, within this task, an object of the present invention is to provide a support structure which should allow changing the relative tilt between the anchoring element and the support element in a simple and effective manner.

Last but not least, an object of the finding is to conceive a support structure exhibiting a competitive production cost, so that the use thereof may be advantageous also from the economic point of view.

Such objects are achieved by a structure manufactured according to the following claim 1. The dependent claims describe embodiment variations.

Further features and advantages of the invention will appear more clearly from the description of some preferred but non-exclusive embodiments of a mounting system or support structure, particularly but not exclusively for television sets according to the invention, illustrated by way of a non-limiting example in the annexed figures, wherein:

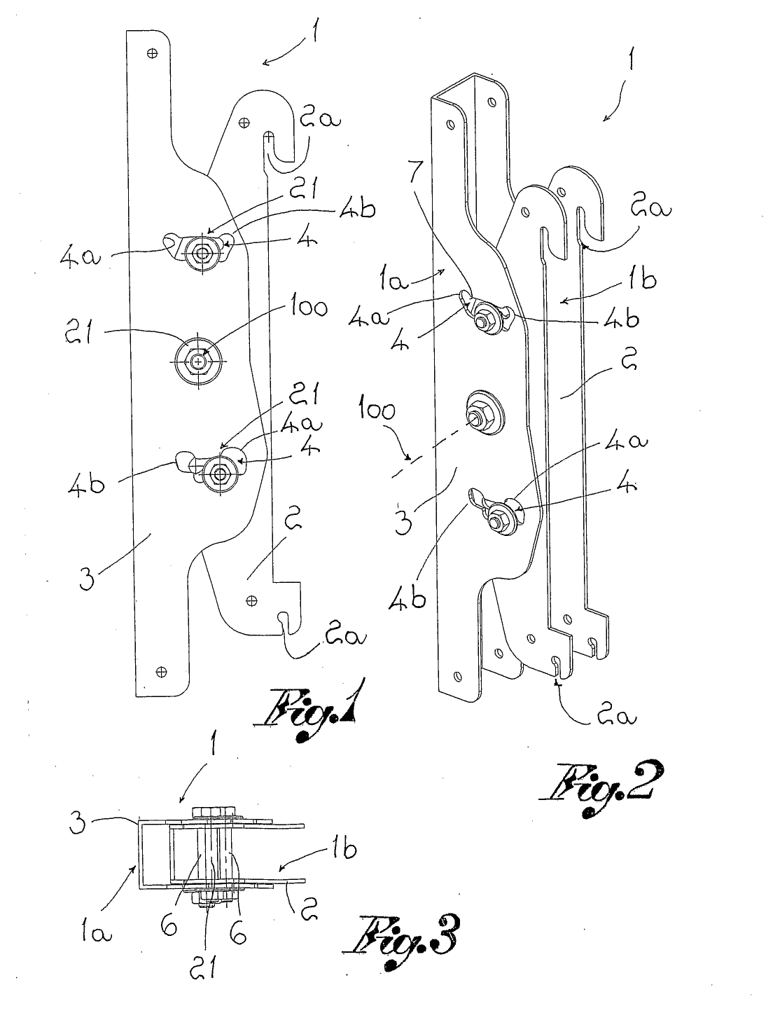

FIG. 1 shows a side elevation view of a support structure according to the present finding;

FIG. 2 shows a perspective view of the support structure illustrated in FIG. 1;

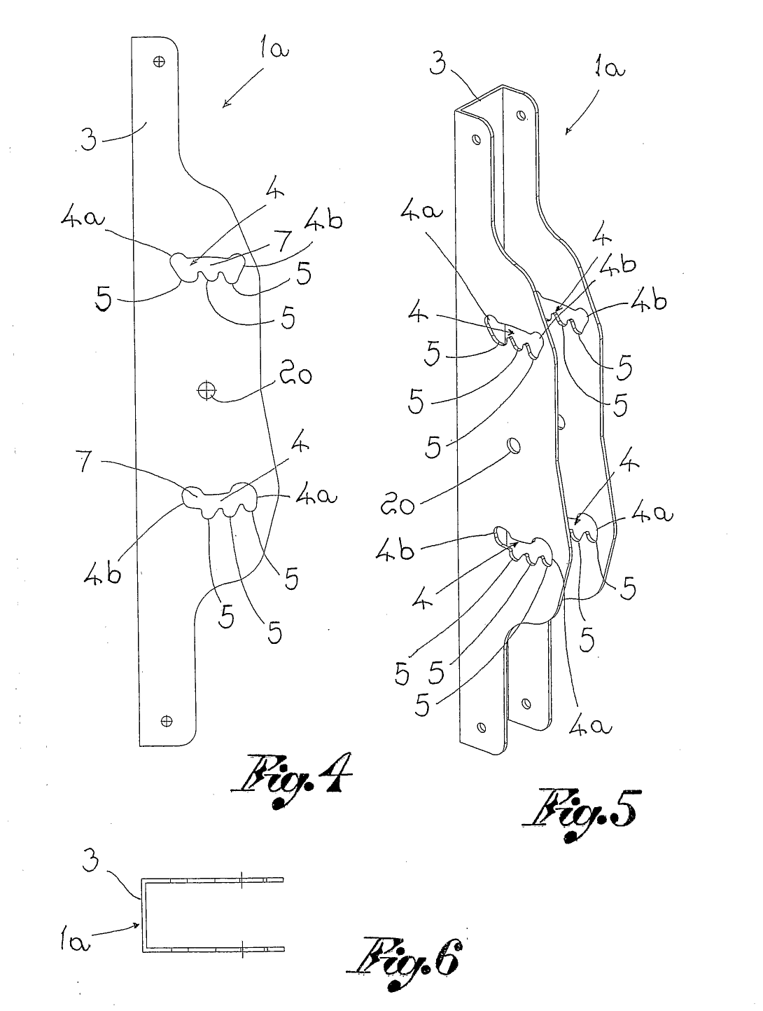

FIG. 3 shows an elevation top view of the support structure shown in FIGS. 1 and 2;

FIG. 4 shows a side elevation view of a support element;

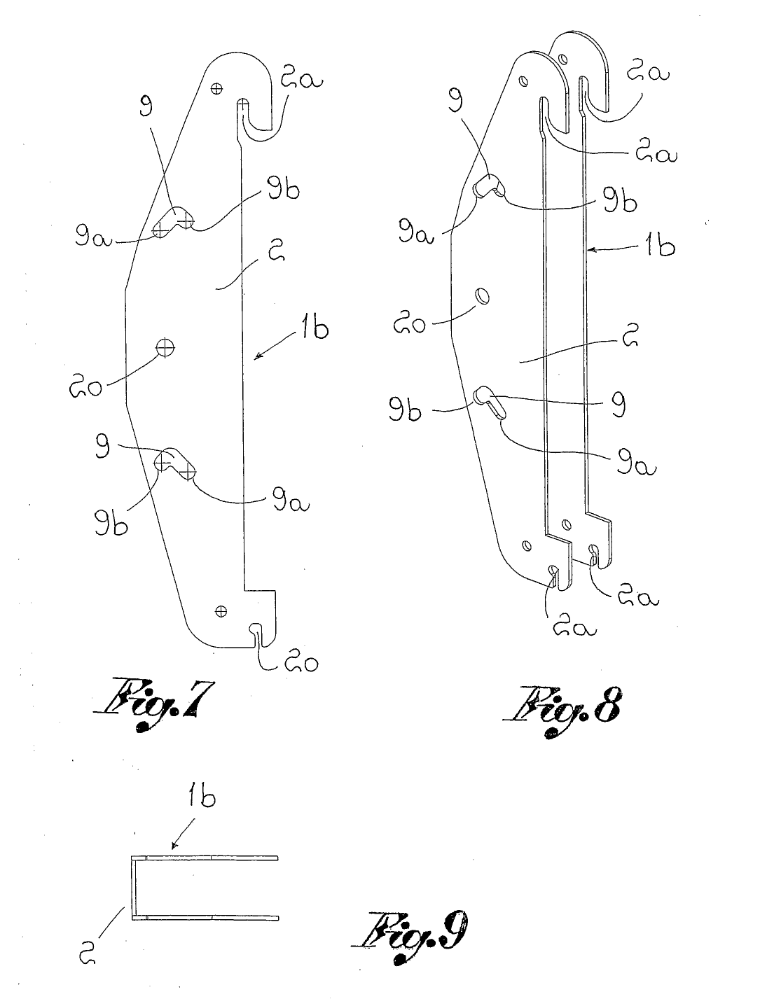

FIG. 5 shows a perspective view of the support element illustrated in FIG. 4;

FIG. 6 shows an elevation top view of the support element shown in FIGS. 4 and 5;

FIG. 7 shows a side elevation view of the anchoring element;

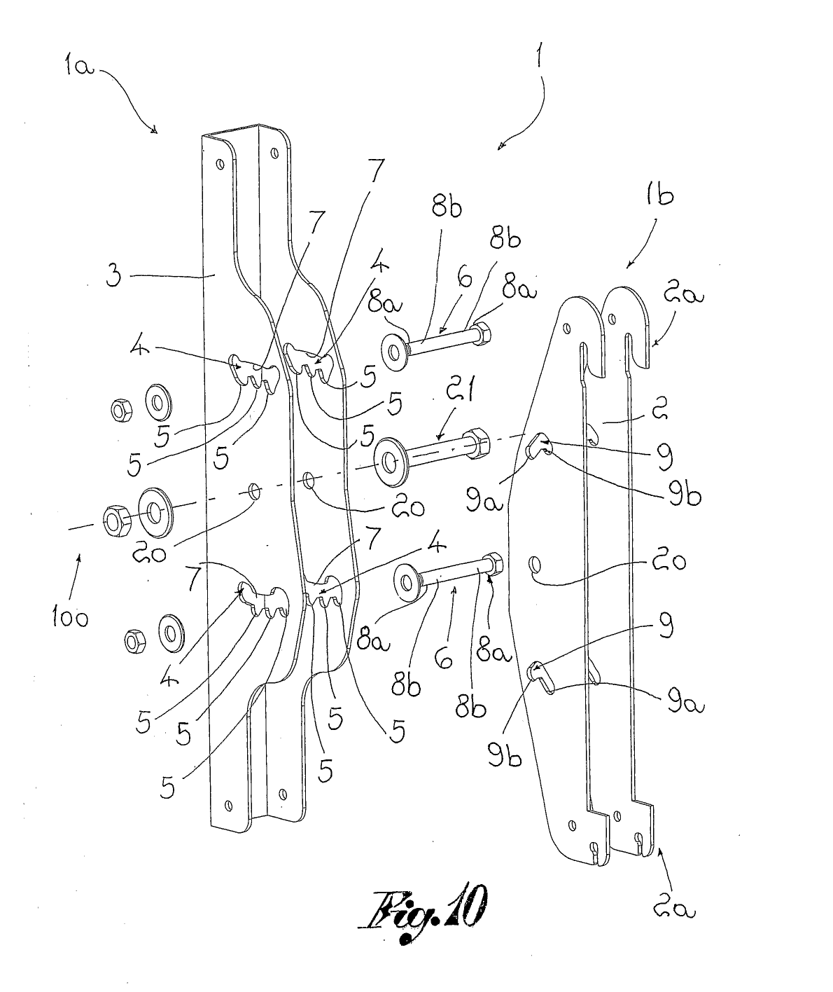

FIG. 8 shows a perspective view of the anchoring element illustrated in FIG. 1;

FIG. 9 shows an elevation top view of the anchoring element shown in FIGS. 7 and 8;

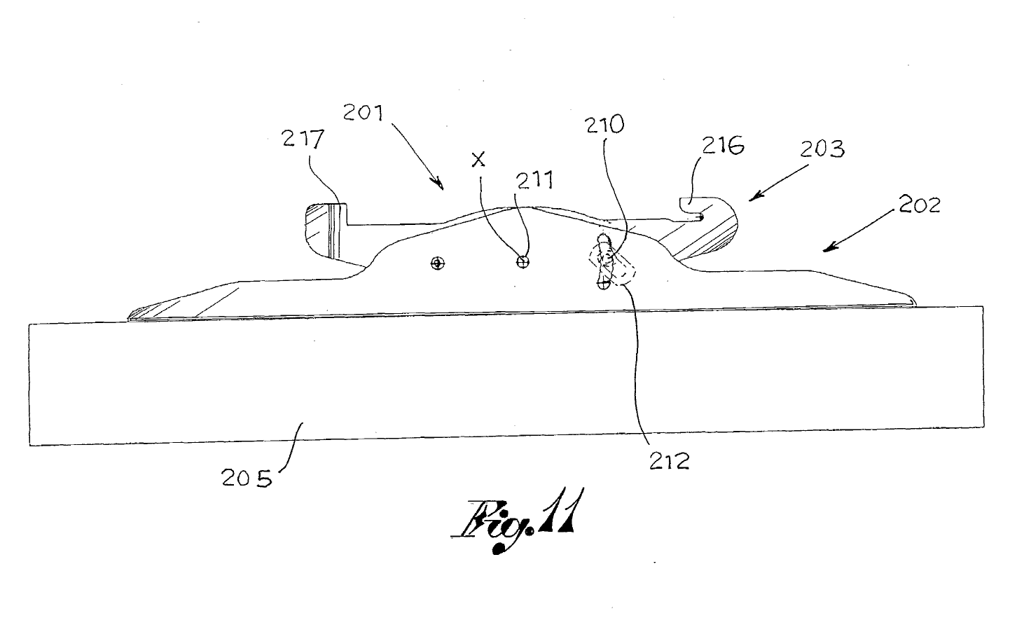

FIG. 10 shows a perspective exploded view of a support structure according to the present finding;

FIG. 11 shows a side view of a mounting system for a device, according to the present invention;

FIG. 12 shows a further side view of the mounting system of FIG. 11, tilted;

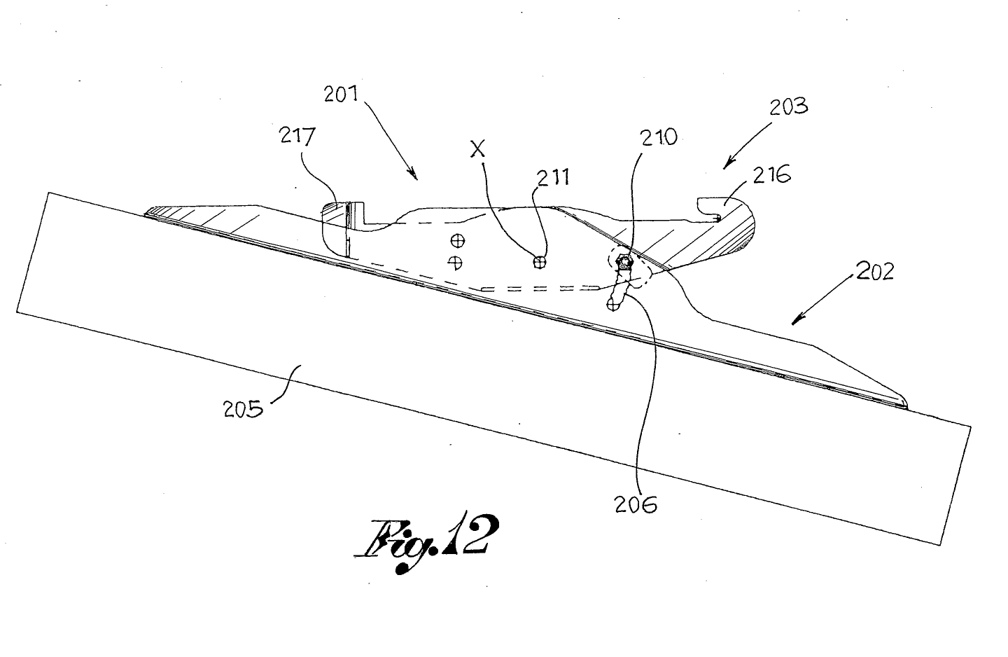

FIG. 13 shows a detail of the mounting system of FIG. 12, in engaged position;

FIG. 14 shows a detail of the mounting system of FIG. 12, in disengaged position;

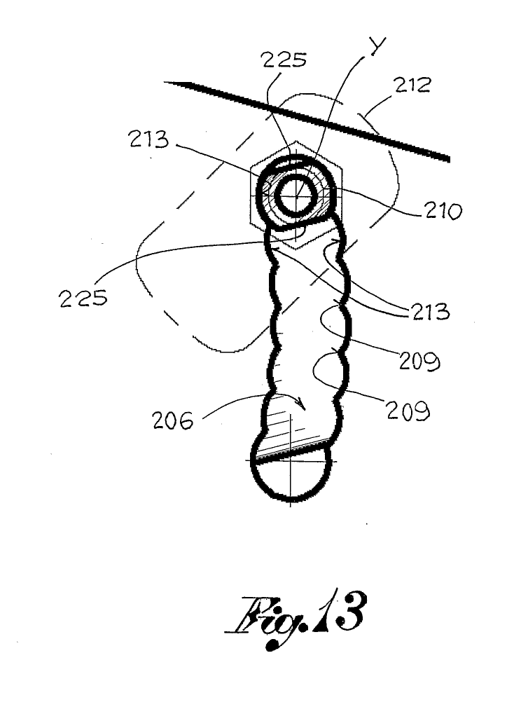

FIG. 15 shows a bottom view of the mounting system of FIG. 11 associated to a support interface;

FIG. 16 shows a front view of the mounting system of FIG. 15;

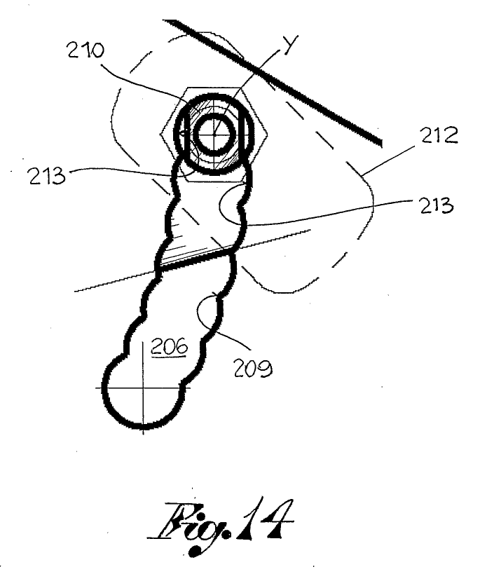

FIG. 17 shows a three-dimensional view of a mounting support of the mounting system of FIG. 11;

FIG. 18 shows a bottom view of the support of FIG. 17;

FIG. 19 shows a side view of the support of FIG. 17;

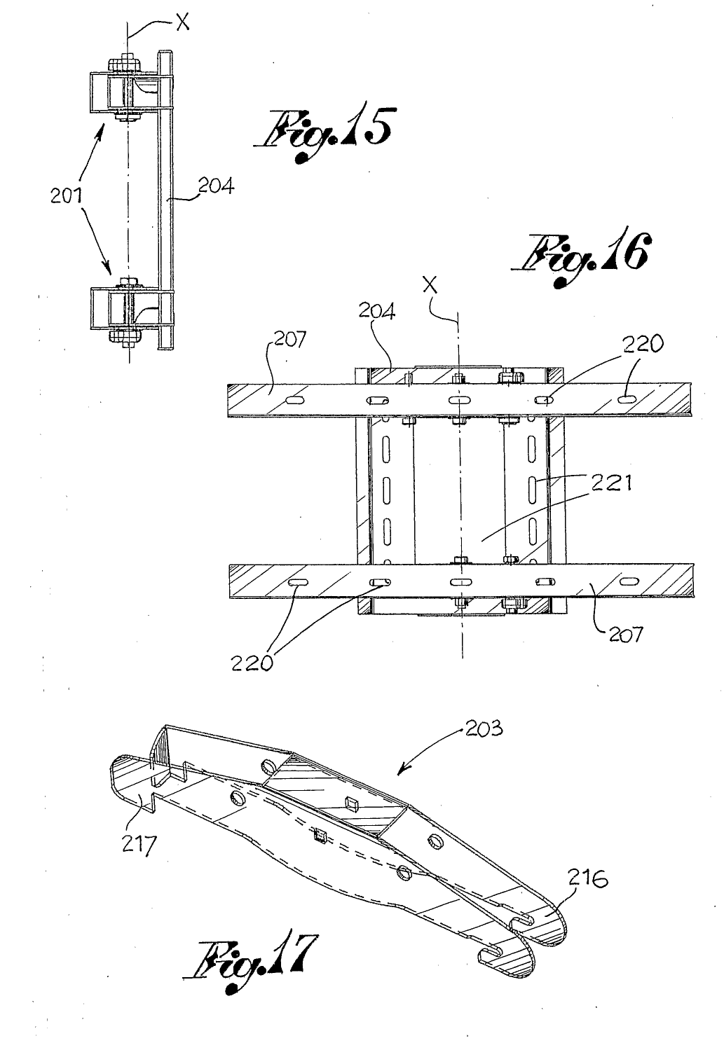

FIG. 20 shows a three-dimensional view of supports of FIG. 17;

FIG. 21 shows a side view of a support of FIG. 17;

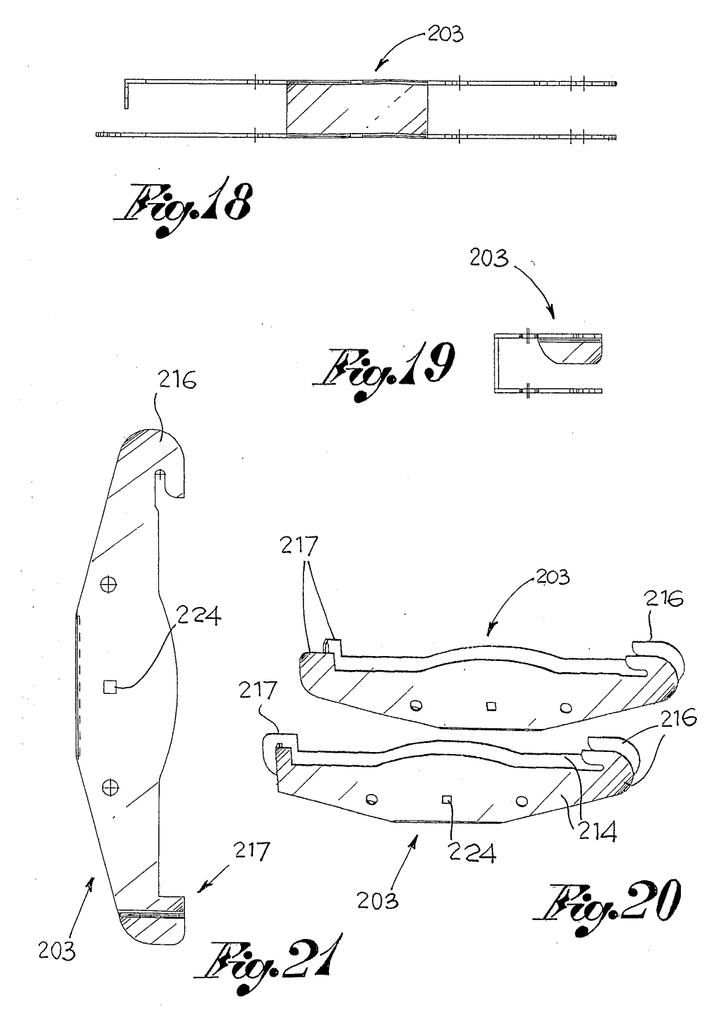

FIG. 22 shows a three-dimensional view of a mounting structure of the mounting system of FIG. 21;

FIG. 23 shows a front view of the structure of FIG. 22;

FIG. 24 shows a further three-dimensional view of the structure of FIG. 22;

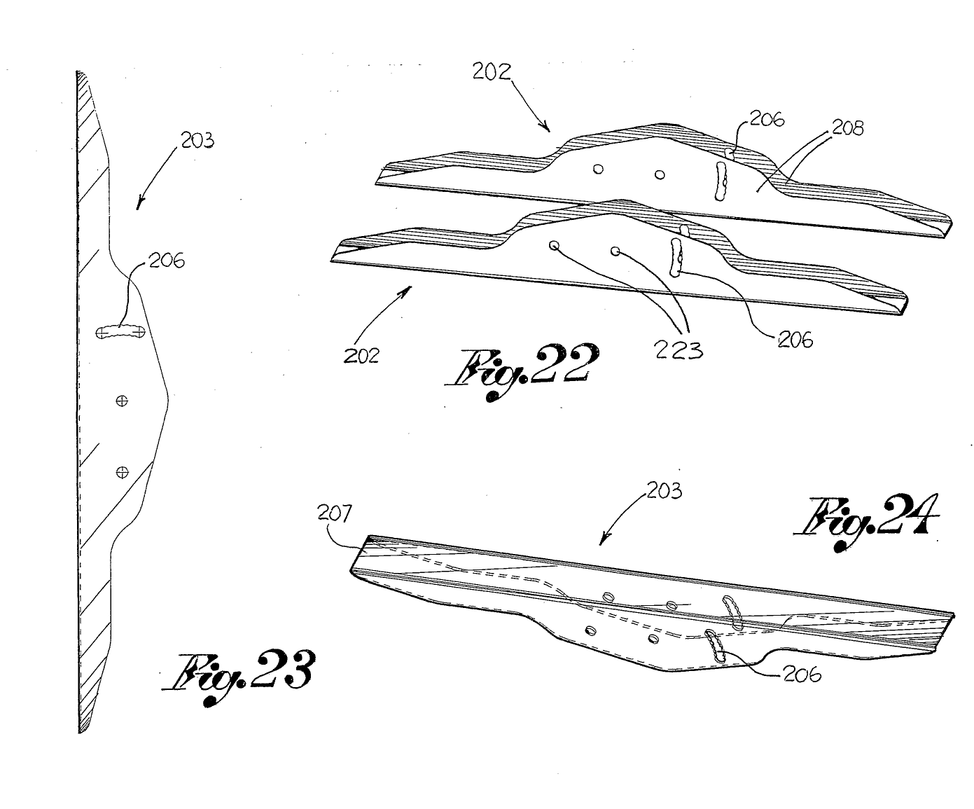

FIG. 25 shows a front view of the mounting system of FIG. 15;

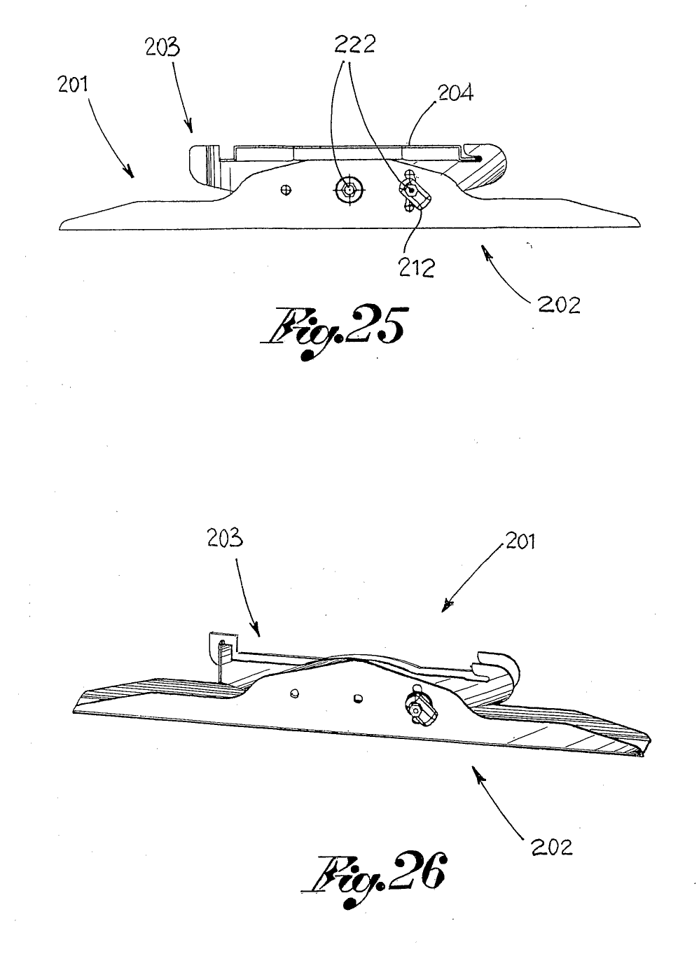

FIG. 26 shows a front view of the mounting system of FIG. 11;

FIG. 27 shows a three-dimensional view of the mounting system of FIG. 11 associated to a support interface and to a device;

FIG. 28 shows a three-dimensional view of the mounting system of FIG. 27, tilted;

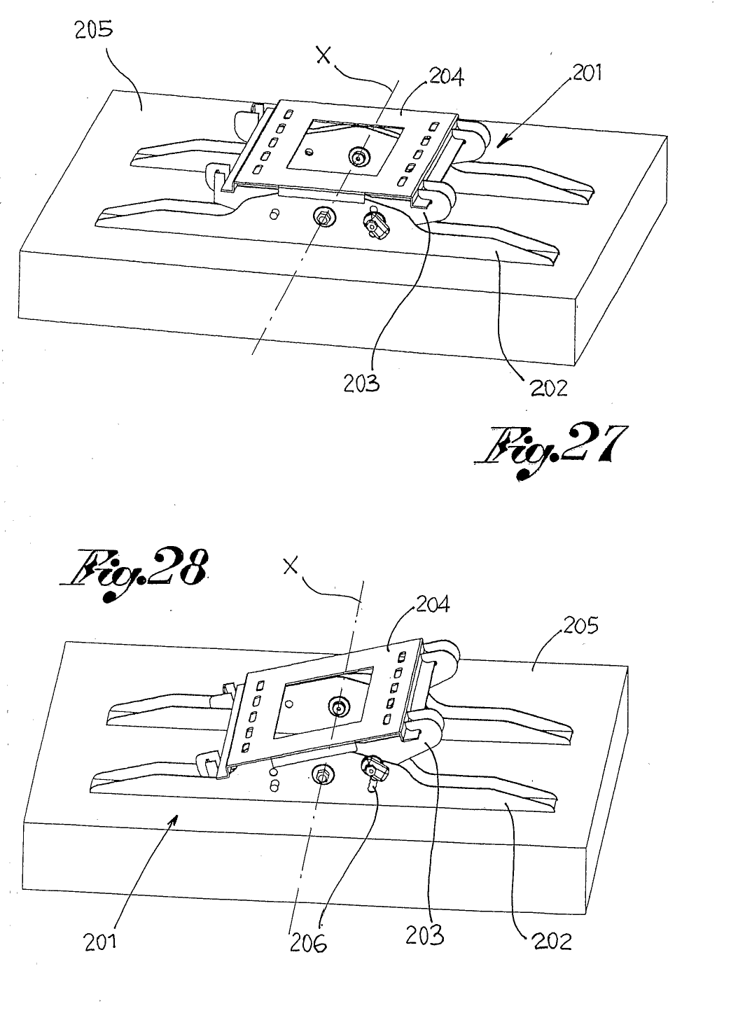

FIG. 29 shows a further three-dimensional view of the mounting system of FIG. 11 associated to a support interface;

FIG. 30 shows a further three-dimensional view of the mounting system of FIG. 11 associated to a support interface and to a device;

FIG. 31 shows a detail of the mounting system of FIG. 25;

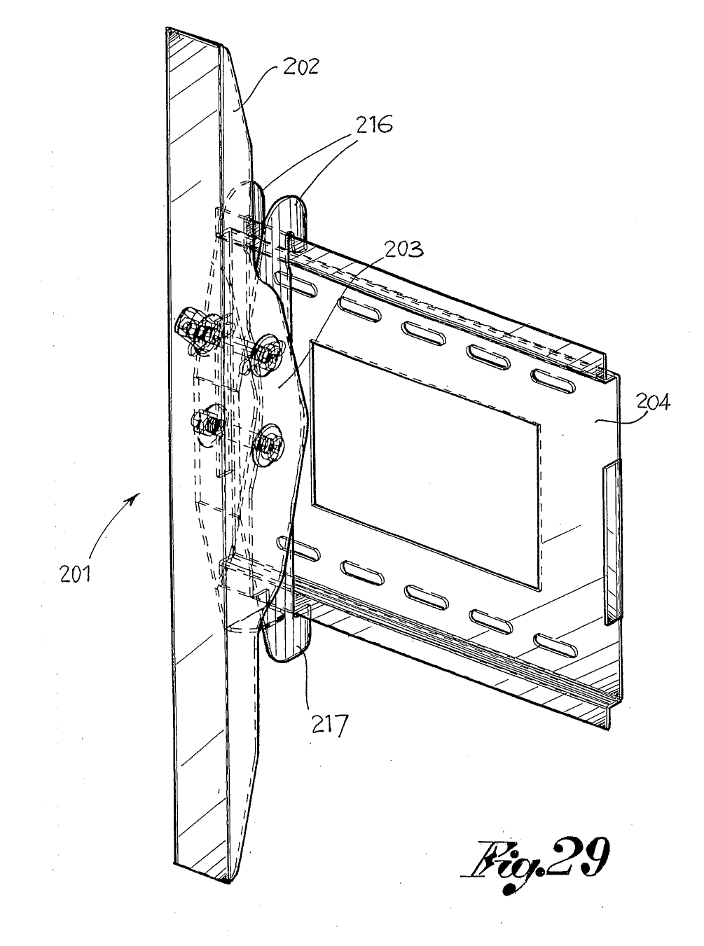

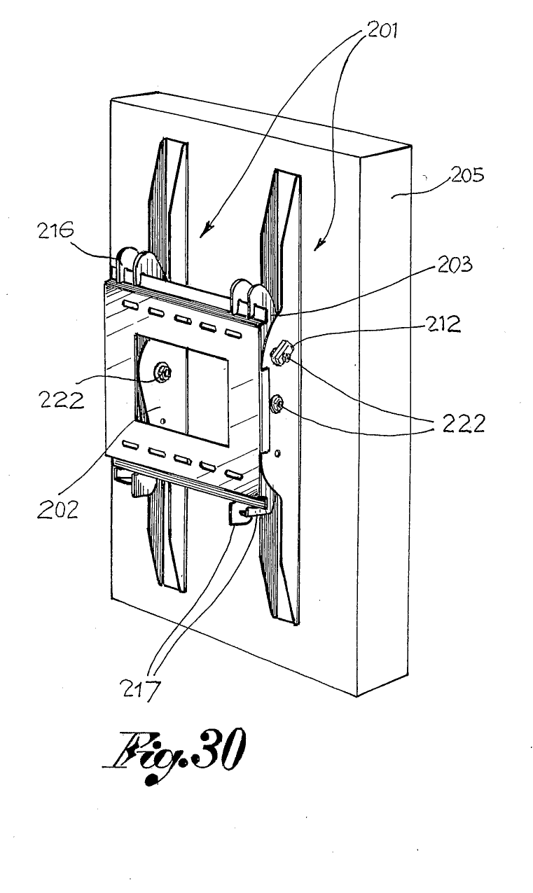

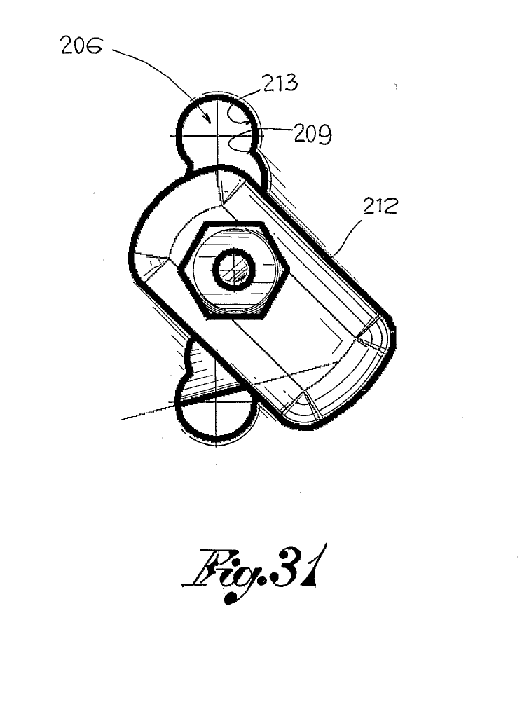

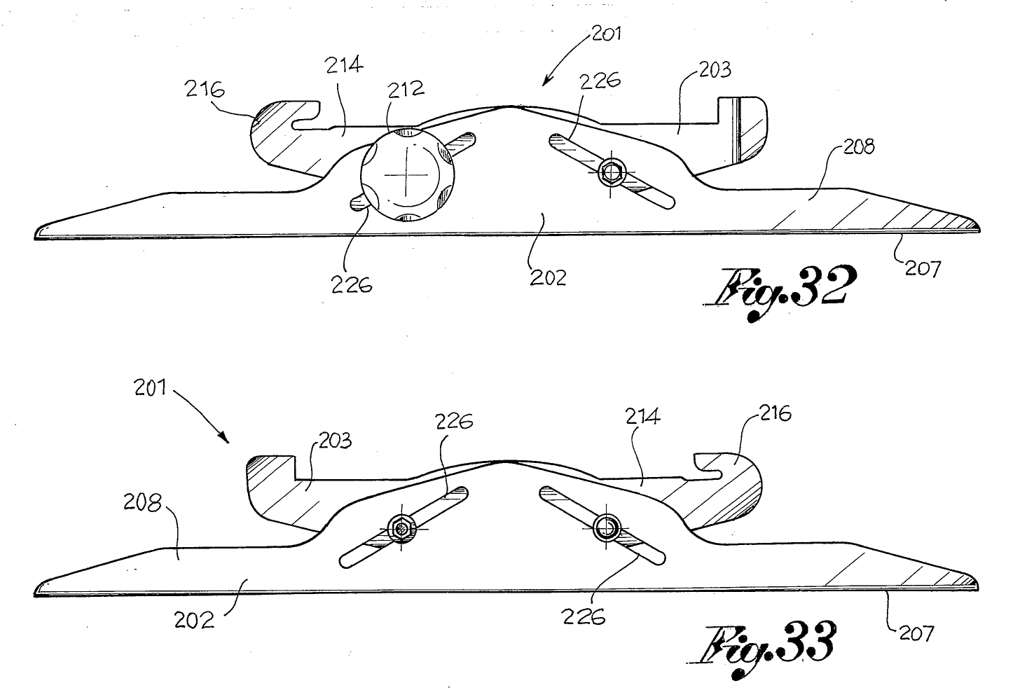

FIG. 32 shows a front view of an optional embodiment of a mounting system for a device;

FIG. 33 shows a back view of the optional embodiment of FIG. 32;

FIG. 34 shows an axonometric view of a device mounted on a pair of mounting systems fixed to a support interface;

FIG. 35 shows a side view of the assembly of FIG. 34;

FIG. 36 shows an axonometric exploded view of a mounting system according to a further embodiment, wherein there are provided guides suitable for allowing the oscillation, arranged on only one side of the system relative to the oscillation axis;

FIG. 37 shows an axonometric exploded view of a mounting system according to an even further embodiment, wherein there are provided guides suitable for allowing the oscillation, arranged on both sides of the system relative to the oscillation axis;

FIGS. 38 to 41 show four axonometric views of different mounting systems connected to respective support interfaces;

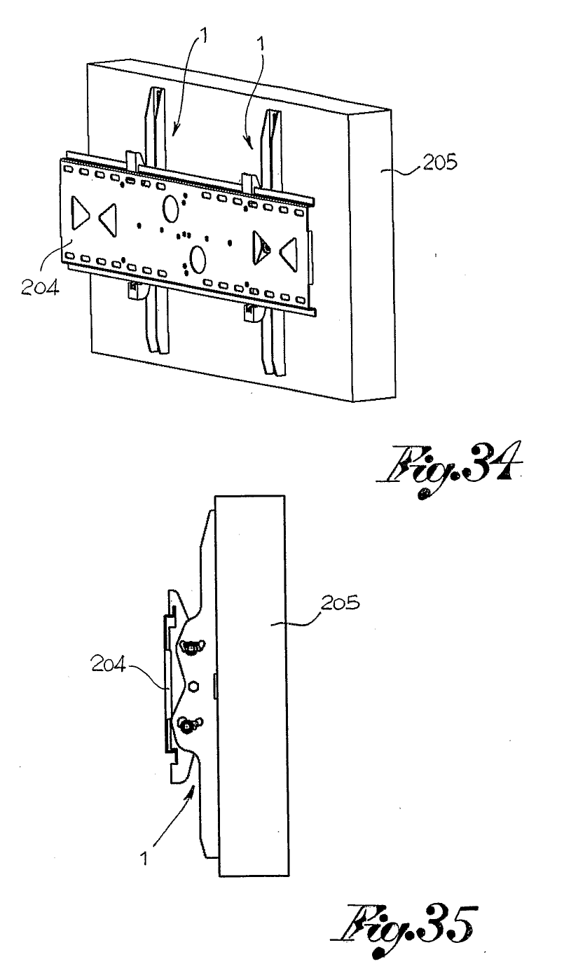

FIG. 42 shows an axonometric view of a mounting structure;

FIG. 43 shows an axonometric view of a mounting support connectable to the mounting structure of FIG. 42;

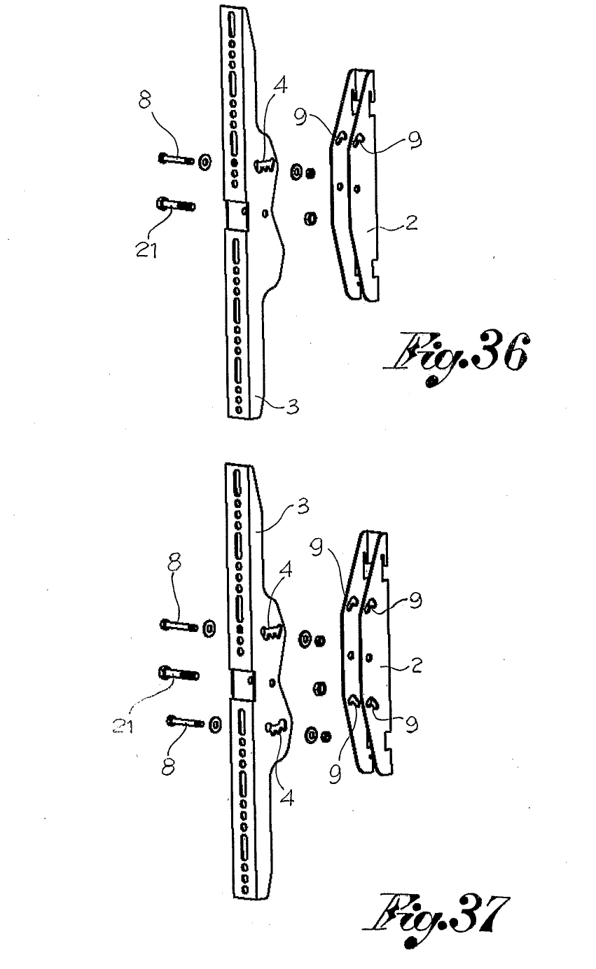

FIGS. 44 and 45 show an axonometric view of a mounting support according to a further embodiment and a detail of said support relating to a shelf thereof with seat for seating removable locking means to a support interface;

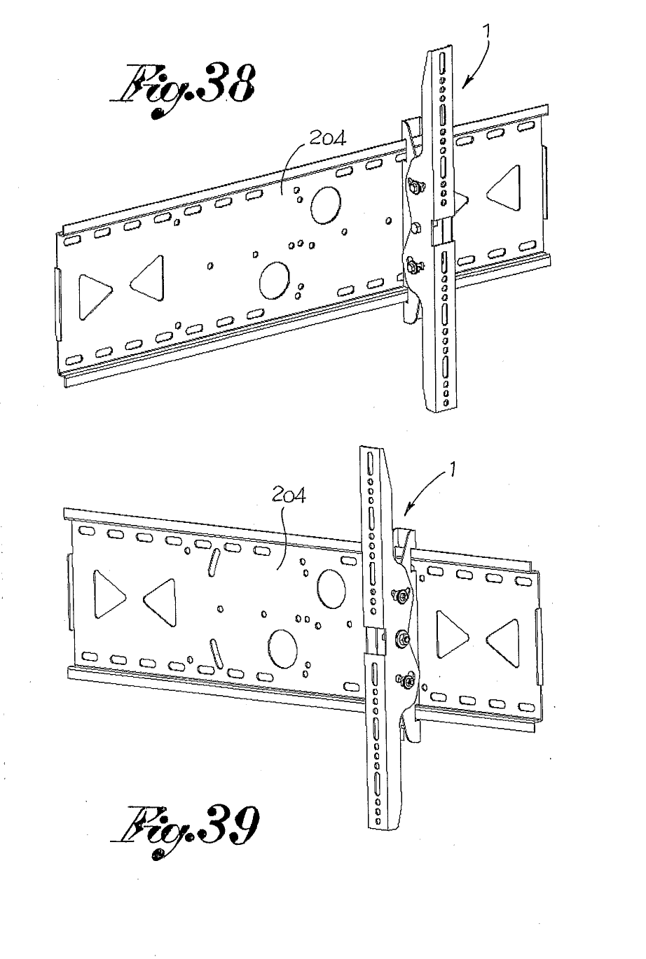

FIGS. 46 and 47 show an axonometric exploded view of a mounting step of two mounting systems to a device and a detail of the mounting step;

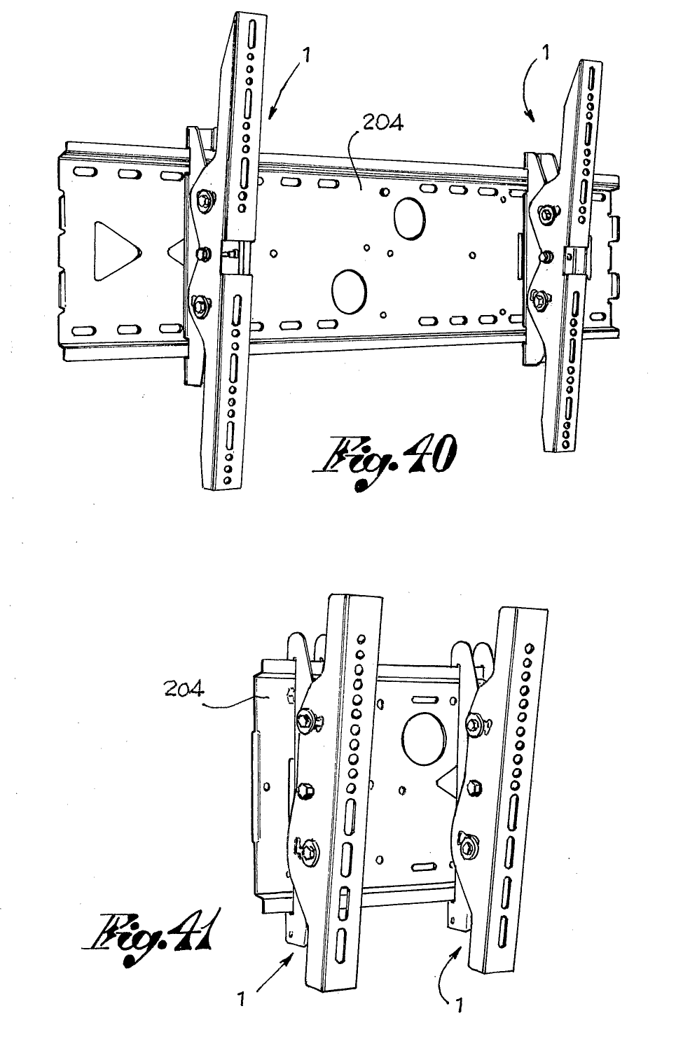

FIGS. 48 to 50 show axonometric exploded views of three different mounting steps of a mounting system according to the invention;

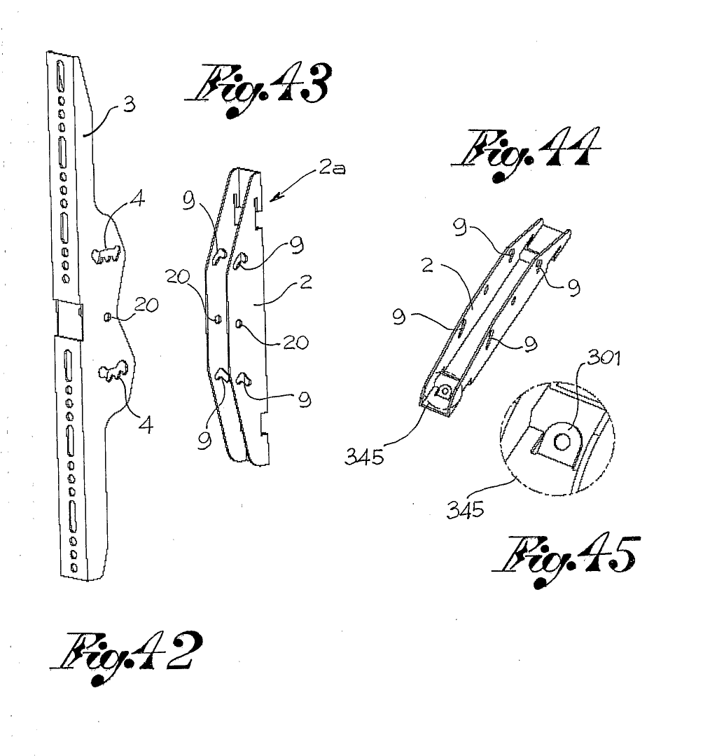

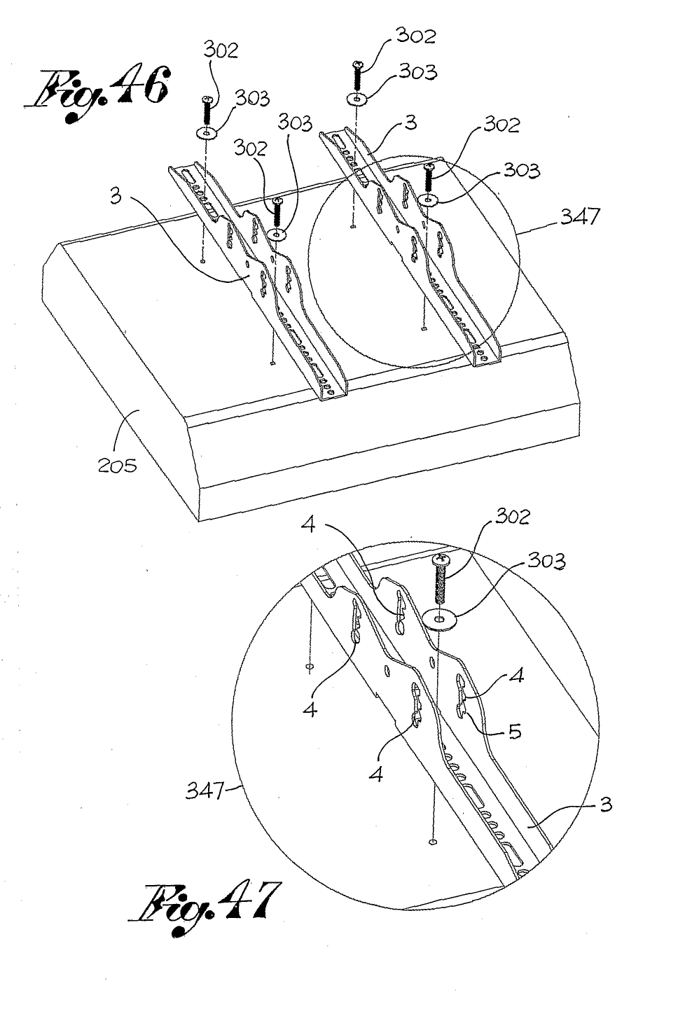

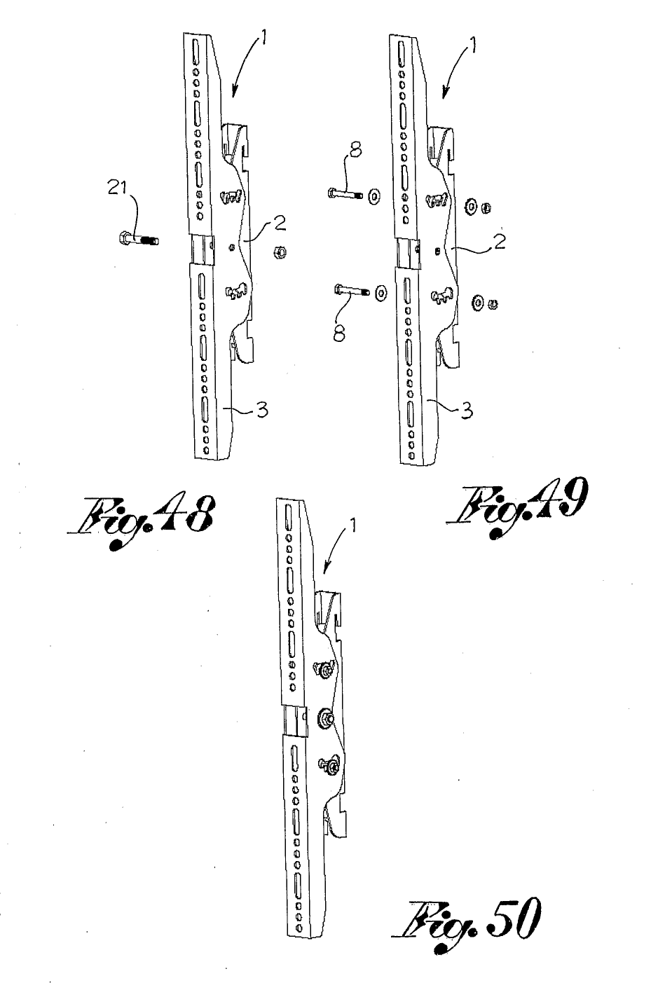

FIGS. 51 to 56 show side exploded views of a mounting system and four details relating to lock and release portions or collimation windows of an anchoring element and to engagement portions or guides with engagement grooves of a support element;

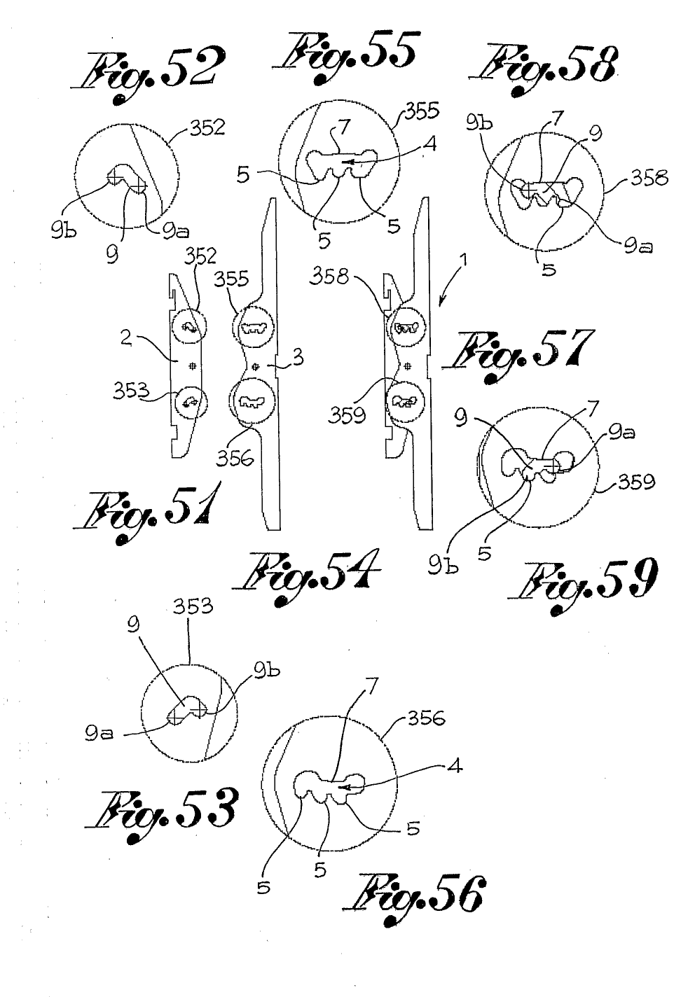

FIGS. 57 to 59 show side views of a mounting system or support structure and details thereof of the lock and release portions or collimation windows facing the engagement portions or guides;

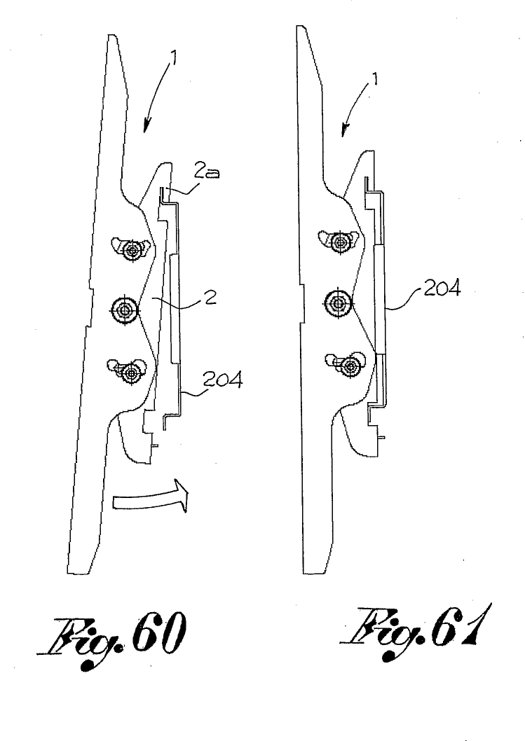

FIGS. 60 and 61 show side views of two mounting steps of a mounting system to a support interface;

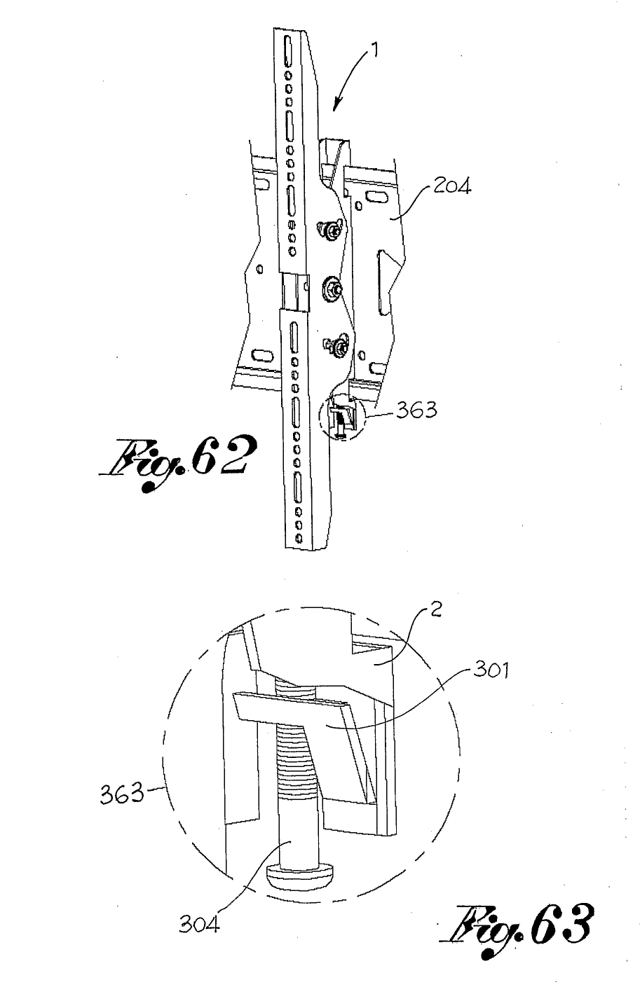

FIGS. 62 and 63 show axonometric views of a locking step of the mounting system to a support interface and a detail of the locking means seated in the relevant shelf with seat of the anchoring element;

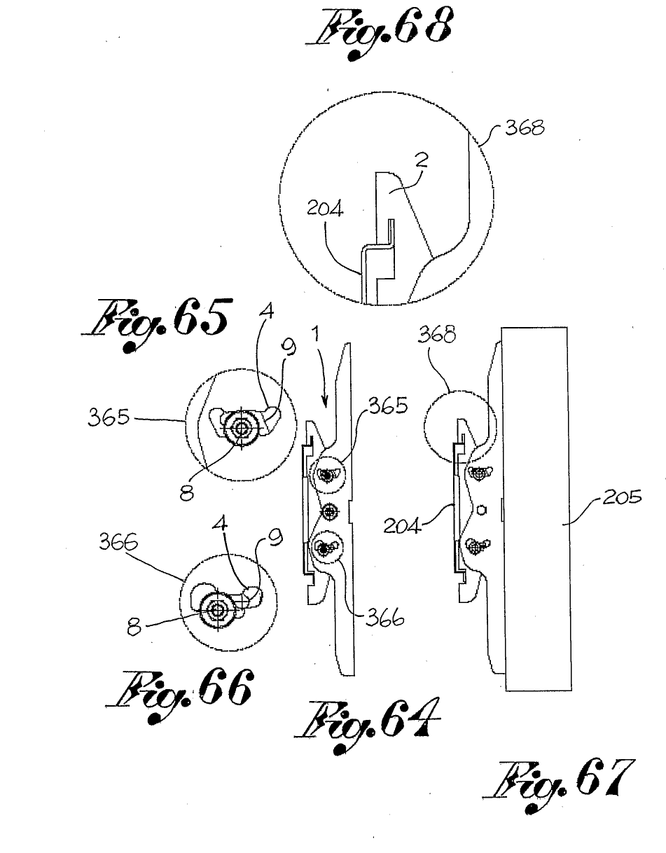

FIGS. 64 to 66 show side views of a mounting system and details thereof of the facing guides and collimation windows with the seated locking element;

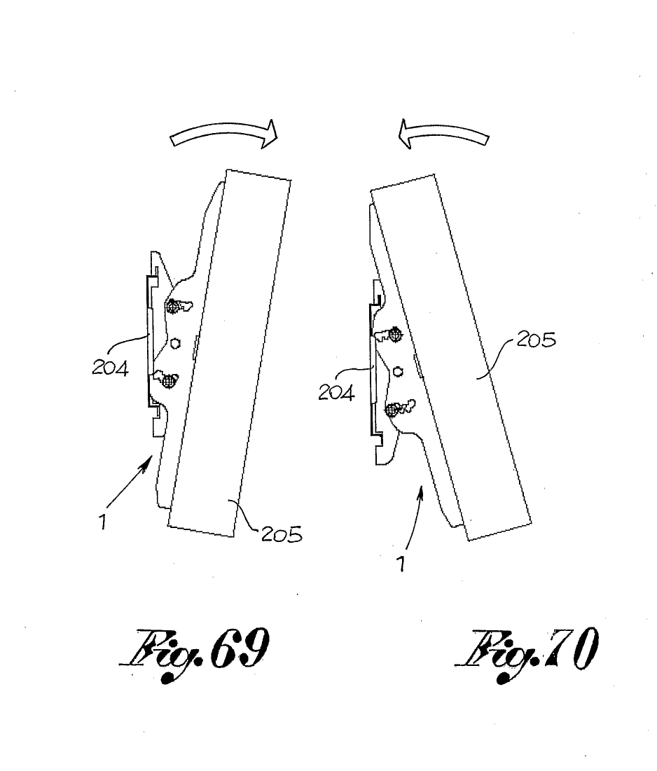

FIGS. 67 and 68 show side views of a device mounted on a mounting system fixed to a support interface and of a detail of connection thereof to the support interface;

FIGS. 69 and 70 show side views of two oscillation positions of a mounting system.

As can be seen in the figures listed above, in accordance with a general embodiment of the invention, there is provided a mounting system or support structure 1; 201 for a device 205 such as a household appliance, a monitor, a television screen, a flat screen. Said mounting system 1; 201 is suitable for allowing a predetermined oscillation of said device 205 about an axis 100; X passing through said mounting system 1; 201, for the positioning in one of a plurality of predetermined balance positions of said device 205. Said mounting system 1; 201 comprises at least one mounting structure or support element 3; 202 suitable for integrally connecting said device 205 to said mounting system 1; 201 in a selectively removable manner.

Said system further comprises a mounting support or anchoring element 2; 203 for integrally fixing said mounting system 1; 201 to a support interface 204 in a selectively removable manner, said support 2; 203 being pivoted along said axis 100; X to said mounting structure 3; 202 so that said mounting structure 3; 202 is tilting relative to said support by an oscillation about said axis 100; X.

Advantageously, said mounting structure 3; 202 comprises coupling means comprising at least one guide 4; 206 suitable for allowing said oscillation of said mounting structure 3; 202 about said axis 100; X.

In the following examples of embodiments, single features described with reference to specific examples may actually be interchanged with other different features, existing in other examples of embodiments.

Moreover, it should be noted that should any things be found to be already known during the patent issue procedure, they should be understood as not claimed and disclaimed from the claims.

With reference to the Figures mentioned above, a support structure, in particular but not exclusively for supporting television sets, household appliances and the like, globally indicated with reference numeral 1, comprises two portions, 1a and 1b.

According to the embodiment illustrated in the Figures, the portion denoted by reference numeral 1a consists of an anchoring element 2 while that denoted by reference numeral 1b consists of a support element 3.

Of course, nothing prevents portion 1a from consisting of the support element 3 and, consequently, portion 1b from consisting of the anchoring element 2.

The two portions 1a and 1b are turnably articulated about an oscillation axis 100; in particular, in the case of support structures for television sets, the oscillation axis 100 lays on a substantially horizontal plane.

Suitably, on both portions 1a and 1b there may be provided one or more holes 20 to this end, engageable by a pin 21 developing along a development direction substantially corresponding to the oscillation axis 100.

At portion 1a of the support structure 1 there is provided at least one guide or guiding window or also engagement portion 4 which defines at least two seats or engagement grooves 5.

The engagement grooves 5 are shaped so as to allow seating a locking element 6 (or also a portion of the above locking element 6) which is, for example, supported also by the other portion 1b of the support structure 1.

In particular, by moving the two portions 1a, 1b along a first relative moving direction about the oscillation axis 100, the locking element 6 is suitable for engaging in a sequence, and in a steady manner (and automatically), the engagement grooves 5 defined along the engagement portion 4 whereas by moving the two portions 1a and 1b along the other (or the second) relative moving direction (from one end 4a towards the other end 4b of the engagement portion 4), the locking element 6 is suitable for moving in a disengagement condition relative to the engagement grooves 5 along the engagement portion 4.

In accordance with an embodiment, the anchoring element 2 is fixable, by first fixing means consisting, for example, of the slits with substantially vertical development 2a, to a structural element (such as a wall or a bearing structure) whereas the support element 3 is fixable, by second fixing means (such as by screw/nut screw coupling 302 with optional washers 303 or spacers, or nut and bolt; FIGS. 46 and 47), to an object to be supported such as a household appliance, a work surface or, preferably, a flat plasma or LCD television set.

In accordance with an embodiment, the engagement portion 4 extends along an arc or circumference portion centred at the oscillation axis 100.

Suitably, the (or each) engagement portion 4 comprises a respective sliding portion within which the locking element 6 slides when the relative moving between the two portions 1a and 1b occurs along the second moving direction and thus, when the locking element 6 is disengaged relative to the engagement grooves 5.

With special reference to the embodiment illustrated in the Figures, in use, the above sliding portion 7 is arranged on top of the engagement grooves 5.

In accordance with an embodiment, engagement grooves 5 are shaped as ratchet gears (for example, with shaped sides reclined in one direction) so as to steadily hold the seated portion of locking element 6 in one direction and allow the passing over in the opposite direction.

It is advantageous to provide for the locking element 6 to consist of a pin element 8 which exhibits a first engagement element 8a (consisting for example of one or both end portions of the pin element 8) slidingly associated to the engagement portion 4 defined on one of the two portions 1a and a second engagement element 8b slidingly supported by a collimation window or lock-release portion 9 defined on the other portion 1b of the support structure 1 and, advantageously, arranged substantially facing a respective engagement portion 4.

Suitably, the lock-release portion 9 is shaped as an upturned V: such upturned V exhibits a first bottom end 9a which substantially extends up to the height of the engagement grooves 5 and the other end or second bottom end 9b which extends up to the development height of the disengagement portion 7 (FIGS. 51 to 59).

The first relative moving direction evidently develops from bottom end 9b toward bottom end 9a.

With reference to the embodiment illustrated in the Figures, each of the two portions 1a and 1b comprises a pair of shoulders: on each shoulder there are respectively defined at least one engagement portion 4 and at least one lock-release portion 9.

According to a preferred embodiment, at portion 1a the support structure 1 exhibits two engagement portions 4 arranged one at the bottom and the other at the top relative to the oscillation axis 100 or at opposite sides relative to the oscillation axis 100.

Similarly to what described hereinbefore, each of the two engagement portions 4 is provided with at least two engagement grooves 5 for a respective locking element 6 supported by the other portion 1b of the support structure 1.

By the relative movement, along a first moving direction, between the two portions 1a and 1b about the oscillation axis 100, a respective locking element 6 is suitable for engaging, alternately, in a sequence and in a steady and automatic manner, an engagement groove 5 of the two engagement portions 4.

It is clear that it is possible to double the engagement grooves 5 along a same oscillation portion, optionally ensuring greater possibility of angular adjustment between the two portions 1a and 1b.

The operation of the mounting device according to the present finding clearly follows from the above description.

In particular, in the first place the element to be supported (such as a plasma television set 205) is fixed to the support element 3 and the anchoring element 2 is fixed to the wall, for example by arranging a support interface 204 thereinbetween (FIGS. 46 to 49 and 60 to 67).

In accordance with an embodiment, the anchoring element 2 is fixed to a support interface 204 by removable locking means 304 (such as a screw) seated in a threaded seat of a shelf 301, provided in the anchoring element 2, facing the support interface 204 (FIGS. 62 and 63).

If one wants to adjust the tilt of the television set, with reference to the embodiment illustrated in the Figures, a force is exerted on the television set itself to move it about the oscillation axis in counterclockwise direction relative to the anchoring element (FIG. 70).

The relative movement imparted determines the disengagement of the locking element 6 from the engagement groove 5 following the raising of the height of the locking element 6 itself, which in this step slides along the lock-release portion 9 shaped as an upturned V and, in particular, along the rectilinear portion extending from the bottom end 9a to the top.

Continuing with the rotation in counterclockwise direction of the support element 3, when another engagement groove 5 is underneath the locking element 6, by gravity the locking element 6 itself is moved at the same time downwards, and in particular, with the first engagement element 8a thereof inside such engagement groove 5 and with the second engagement element 8b thereof at the bottom end 9a of the lock-release portion 9.

The passage of the locking element 6 from one engagement groove 5 to that arranged downstream along the first moving direction occurs without the need of acting on the locking element 6 itself but simply moving the support element 3 in such direction relative to the anchoring element 2.

Once the engagement groove 5 located more downstream has been reached, continuing with the rotation of the support element 3 along the first moving direction, determines a sliding of the locking element 6 along the entire rectilinear portion extending from the bottom end 9a to the top, to then move down again along the shorter portion to move at end 9b arranged at a higher height than the inlet of the engagement grooves 5. In this way, by moving the support element 3 in clockwise direction relative to the anchoring element 2, the locking element 6 slides along the sliding portion 7 defined on the engagement portion 4 until it reaches the other end of the engagement portion 4. In fact, once such other end has been reached, due to the relative movement with the edge defining such other end, the locking element 6 moves upwards along the rectilinear portion extending from the bottom end 9b to the top to then move down again towards end 9b and towards an engagement groove 5 (FIG. 69).

All the features of the finding, hereinbefore indicated as advantageous, suitable or the like, may even be lacking or be replaced with equivalent ones.

Several changes and variations can be made to the finding thus conceived, all falling within the scope of the inventive concept.

In the practice, it has been found that in all the embodiments, the finding has achieved the task and the objects thereof.

In the practice, the materials used as well as the sizes, can be whatever, according to the requirements.

Moreover, all details can be replaced with other technically equivalent elements.

Where the technical features in the claims are followed by numerical references and/or codes, said numerical references and/or codes have been added only for the purpose of increasing the intelligibility of the claims and thus, such numerical references and/or codes have no effect on the scope of each element identified by said numerical references and/or codes only by way of an example.

In accordance with further embodiments, reference numeral 201 globally denotes a mounting system for a device 205, such as a television screen, a monitor, a CRT monitor, an LCD monitor, a flat screen and the like.

The mounting system 201, in particular, is a tilting mounting and support system of device 205, for angularly orientating device 205 itself as desired.

The mounting system 201 comprises at least one mounting structure 202 suitable for integrally connecting said device 205 to said mounting system 201 in a selectively removable manner.

The mounting structure 202 comprises at least first coupling means that allow an oscillation of said mounting structure 202 about an axis X.

Moreover, the mounting structure 202 comprises at least second coupling means that determine a plurality of predetermined positions.

According to the present invention, said mounting system 201 further comprises at least one mounting support 203 for integrally fixing said mounting system 201 to a support interface 204, in a selectively removable manner.

Support 203 comprises at least first coupling counter-means suitable for cooperating with said first coupling means for coupling said support 203 to said mounting structure 202 and for allowing said oscillation of said mounting structure 202.

Moreover, support 203 comprises at least second coupling counter-means suitable for cooperating with said second coupling means for selectively defining a predetermined angular position of said mounting structure 202 relative to said support 203.

According to an embodiment of the present invention, the mounting system 201 also comprises the support interface 204.

Thus, preferably, the support interface 204 exhibits mounting apertures 221 for integrally connecting in a selectively removable manner said support interface 204 to a flat surface, such as a vertical and/or horizontal flat surface, a wall, a partition the like, for example by fixing means, such as screw means, bolts, hooks and the like.

Preferably, said first coupling means comprise at least first through holes 223.

According to a preferred embodiment, the first through holes 223 are arranged centrally in the mounting structure 202 and reciprocally aligned, or with the central axis in common.

Alternatively, the first through holes 223 are arranged laterally in the mounting structure 202, to change the oscillation range, or the tilting angle, of the mounting structure 202 relative to support 203.

Preferably, moreover, said second coupling means comprise a plurality of balance seats 213.

By balance seats 213 it is meant regions or portions of the mounting structure 202 which, in cooperation with said second coupling counter-means, form a plurality of steady and safe angular positions between support 203 and the mounting structure 202 wherein device 205 is in steady balance relative to the mounting system 201 itself.

Moreover, said second coupling means comprise at least one slot 206 that defines said seats 213.

According to a preferred embodiment of the invention, seats 213 are composed of tips 209, or teeth, in a sequence with each other and continuously jointed.

Tips 209 exhibit a substantially smooth and chamfered profile for allowing the sliding, for example by rolling, of the positioning element 210.

According to an aspect of the present invention, slot 206 is a through groove, such as an arched groove or a circular groove or a through guide with rectilinear tilted planes.

Favourably, slot 206 has a substantially curvilinear pattern.

Alternatively, slot 206 has a substantially rectilinear pattern.

Favourably, slot 206 spatially restricts said oscillation of said mounting structure 202 relative to said support 203.

For example, the oscillation is restricted within an arc comprised between 0° and 20°.

In other words, slot 206 defines a restricted and predetermined succession of said seats 213.

Favourably, said first coupling counter-means comprise at least second through holes 224.

According to an embodiment, the second through holes 224 are obtained centrally in support 203 and have the central axis in common, or they are aligned or coaxial.

Moreover, the second through holes 224 are aligned, or coaxial, to the first through holes 223, when support 203 and the mounting structure 202 are properly coupled.

Alternatively, the second through holes 224 are obtained laterally in support 203.

Moreover, said first coupling counter-means comprise at least one rotation element 211.

The rotation element 211 is seated in the first and second through holes 223 and 224 when support 203 is coupled to the mounting structure 22, so as to allow a reciprocal rotation of the latter about the rotation element 211.

Preferably, the rotation element 211 defines a fulcrum about which the mounting structure 202 oscillates relative to support 203.

According to a preferred embodiment, said second coupling counter-means comprise at least one positioning element 210.

According to a preferred embodiment, the mounting structure 202 comprises said plurality of balance seats 213 and is connected to said support 203 so as to allow the oscillation about said axis X for defining said angular position of the mounting structure 202 relative to said support 203.

Moreover, the mounting structure 202 can be selectively positioned, relative to support 203, in at least one of said plurality of relative predetermined angular balance positions between said mounting structure 202 and said support 203.

Each of the angular balance positions can be obtained by the positioning element 210 which selectively engages in at least one of the balance seats 213.

In other words, the positioning element 210 can be geometrically coupled in a selective manner to each of the plurality of seats 213.

In yet other words, the positioning element 210 restricts and selectively locks the oscillation of the mounting structure 202 relative to support 203, defining a succession of steady relative angular positions between the mounting structure 202 and support 203.

Preferably, said positioning element 210 is a positioning pin.

According to a preferred embodiment, said positioning pin 210 has a substantially elongated section, said positioning pin 210 exhibiting at least one flat face 225.

Preferably, moreover, the positioning pin 210 has a substantially oval section.

Favourably, the positioning pin 210 exhibits two opposite flat faces 225 obtained, for example, by deformation by compression of the positioning pin 210, for example in a press.

Preferably, the section of the positioning pin 210 has a larger dimension, suitable for being seated between two corresponding and facing seats 213 and a smaller dimension, suitable for allowing the passage of said positioning pin 210 between two corresponding and facing tips 209 in said slot 206, or the distance between two corresponding and facing tips 209 in slot 206 is greater than the smaller dimension of the section of the positioning pin 210 and moreover, it is smaller than the larger dimension of the section of the positioning pin 210.

Thus, the positioning pin 210 engages seat 213 (FIG. 13) when the larger dimension thereof is fully seated between the two seats 213, or it is geometrically coupled to seats 213; in this case, the mounting system 201 is in engaged position.

When the positioning pin 210 is rotated relative to an axis Y thereof so that it is not coupled to seats 213 anymore, the smaller dimension thereof can pass through the two facing tips 209 (FIG. 14); in this way, the mounting system 201 is in disengaged position.

According to an alternative embodiment, the positioning pin 210 has a substantially elliptical section.

Favourably, therefore, each of said seats 213 has a shape suitable for geometrically coupling with said positioning pin 210.

Thus, each of said seats 213, for example, has a shape substantially at least partly ellipsoidal or oval, so as to geometrically couple with said positioning pin 210 with elliptical or oval section.

In accordance with a preferred embodiment of the present invention, the mounting structure 202 exhibits two side plates 208 or side walls, suitable for reinforcing the mounting structure 202.

Preferably, each plate 208 exhibits slot 206.

Preferably, the side plates 208 are connected by a hooking plate 207 suitable for associating to said device 205 for the tilting thereof.

Plates 208 preferably have a rectilinear bottom profile suitable for being connected, for example by welding, to the hooking plate 207 and a further top profile comprising two broken lines at the ends of the plates, between which there is provided a projection obtained by a further broken line.

Preferably, the hooking plate 207 exhibits hooking holes 220 for the selectively removable hooking and fixing of said mounting structure 202 to said device 205, for example by selectively removable fixing means, such as screw means, bolts, hooks and the like.

The hooking holes 220, moreover, increase the flexibility of the mounting structure 202 when it is associated to device 205.

Favourably, each of said seats 213 is suitable for seating the positioning pin 210 for defining a balance position between said mounting structure 202 and said support 203.

In accordance with a preferred embodiment, the rotation element 211 is a rotation pin that effectively defines said rotation axis X about which said mounting structure 202 can rotate, or oscillate or be tilted, relative to said support 203.

Preferably, support 203 exhibits two side wings 214.

Favourably, the two side wings 214 are connected by a spacer plate 215, for example welded thereto.

Preferably, each of said wings 214 exhibits at a first end a hook 216 or a tab, substantially shaped as a “U”, which exhibits an undercut for the sliding hooking to a top rail 218 of said support interface 204.

Hooks 216, in fact, engages astride of the top rail 218.

Moreover, each of said side wings 214 exhibits at a second end thereof coupling and stopping means that define a flange system 217, which is provided with at least one undercut, for the sliding association to a bottom rail 219 of said support interface 204, so as to form also a safety system for preventing the extraction of support 203 from the support interface 204.

The flange system 217 is substantially composed of an end of wing 214 with substantially rectangular shape and of an end of the further corresponding wing 214, which exhibits a rounded pattern and extending by a length greater than the rectangular end.

Once hook 216 engages the top end of the support interface 204 where the top rail 218 is provided, the flange system 217 is in contact with the bottom rail 219.

In this way, device 205 can be re-positioned laterally sliding along the top rail 218 and the bottom rail 219.

Favourably, the rectangular end exhibits a threaded through hole for seating fixing means, such as screw means, for engaging the support interface 204.

According to a preferred embodiment, each of the side wings 214 exhibits a profile between hook 216 and the flange system 217 comprising for example three consecutive rectilinear edges.

Favourably, moreover, support 203 is seated between said side plates 208, that is, the distance between the side wings, defined by the spacer plate 215 is less than the distance between plates 208, in turn defined by the width of the mounting plate 207.

Thus, support 203 is preferably coupled to said mounting structure 202 by said rotation pin 211.

In fact, the rotation pin 211 is seated in the first through holes 223 obtained on said side plates 208 and in the second through holes 224 obtained on said side wings 214 and screwed by bolt means 222, for preventing the extraction of the rotation pin 211 and thus the disconnection of support 203 and of the mounting structure 202.

In fact, the rotation pin 211 and the positioning pin 210 extend transversally relative to said mounting structure 202 and to said support 203, passing respectively inside said first through holes 223 and said second through holes 224.

Thus, the mounting structure 202 is in steady relative position relative to said support 203 when the positioning pin 210 is fully seated in, or geometrically coupled with, one of said seats 213.

Moreover, the mounting structure 202 is in unsteady position relative to said support 203 when said positioning pin 210 is not seated in one of said seats 213, or is disconnected from seat 213.

In fact, the positioning pin 210 rotates about axis Y thereof and at the same time, moves from said steady position, following the perimeter of slot 206 to move from a first seat 213 to an adjacent seat 213 and at the same time said mounting structure 202 rotates, or tilts or oscillates, relative to said support 203, about axis X.

Favourably, the positioning pin 210 changes from said steady position to said unsteady position and vice versa by a rotation substantially of about 90° about axis Y thereof, thanks to the fact that the smaller dimension of the section of the positioning pin 210 is smaller than the distance between tips 209.

Favourably, the passage of the positioning pin 210 from a first seat 213 to an adjacent seat 213 defines a passage from said first steady relative position to a further steady relative position of the mounting structure 202 relative to said support 203.

Favourably, the steady relative position is a steady relative angular position of said mounting structure 202 relative to said support 203.

According to an aspect of the present invention, the steady relative position is a tilted position of said mounting structure 202 relative to said support 203.

As already explained, according to the present invention, the angular position of said mounting structure 202 relative to said support 203 defines an angle comprised in a range between 0° and 20°.

According to a preferred embodiment, the positioning element 210 is manoeuvrable, or controllable, by a gripping means 212 such as a knob or a lever, suitable for providing a twisting torque to said positioning element 210, for the rotation thereof and for selectively coupling and disconnecting the positioning pin 210 to seats 213.

In other words, the hooking system 201 substantially acts as a rotating cam, wherein a twisting torque is imparted to the positioning pin 210 for the rotation thereof about axis Y, and as a consequence this causes the movement of pin 210 in a subsequent seat 213 and thus a rotation about pin 211 of the mounting system 201, for the variation of the relative angular position between support 203 and mounting structure 202.

According to a preferred embodiment, the hooking or mounting system 201 is provided with a plurality of hooking structures 202 fixed to a device 205 and associated to corresponding supports 203; the latter are hooked to the rails of the support interface 204.

Favourably, therefore, the hooking system 201 exhibits for example two pairs of hooking structures 202 fixed to a device 205 and associated to the corresponding supports 203.

According to an optional embodiment, the mounting system 201 provides for the first and second coupling means to comprise two slots that define two guides with tilted planes 226, inside which the first coupling counter-means slide, for defining an infinite number of steady positions into the slots, such as sliding pins; one of these sliding pins may be even integrated with knob 212 with a fixing screw for locking device 205 in one of the desired steady positions; in this case, the centre of rotation about which the mounting structure 202 oscillates relative to support 203 defines a virtual rotation axis external to the mounting system 201 (FIGS. 32 and 33).

Favourably, the hooking system 201 is made of a metal material, for example steel.

Alternatively, the hooking system 201 can be made of an appropriate polymeric material.

Advantageously, by the mounting system 201, device 205 is positioned in a plurality of predetermined positions, for example allowing the tilt thereof to be adjusted relative to the wall or to the partition, operating on the knob.

In fact, it is advantageous to apply a low twisting torque to the positioning pin 210 by knob 212, to rotate it so as to disconnect it from seat 213 wherein it is seated.

Afterwards, the positioning pin 210 is easily moved and coupled to the desired new balance seat, thus obtaining the desired angular position of device 205.

According to a further advantageous aspect thereof, a single rotation pin 211 is required for coupling the mounting structure 202 to support 203, thus allowing considerable cost and time saving.

Advantageously, the mounting system 201 is provided with a pair of mounting structures associated to corresponding supports that can be easily adjusted by a single operator who manoeuvres the positioning pins 210 at the same time through knobs 212.

Therefore, a single operator can adjust the angular position of device 205, changing the tilt thereof as desired and in a safe manner.

In fact, each balance seat 213 is adjacent to at least one further balance seat, thus ensuring the positioning safety of device 205 and preventing sudden movements or too wide oscillations of the device itself.

Advantageously, moreover, with the mounting system 201, device 205, which can weight between 0 and 100 Kg, is kept in a steady position.

In fact, thanks to the fact that the rotation pin 211 defines an effective and concrete rotation axis X which passes through the mounting system 201, the device weight is released on the mounting system 201, and thus on the wall or partition, in a more effective manner, allowing a considerable capacity, and allowing the use of smaller thicknesses than the standard ones, with significant advantages on the material in terms of cost and time.

Advantageously, moreover, by hooks 206 and the flange system 217, device 205 can be easily re-positioned laterally along the rails of the support interface 204.

According to a further advantageous aspect, moreover, device 205 does not move from the steady position thereof when, for example, it undergoes an accidental shock, since the positioning pin 210 is steadily coupled into seats 213.

It is clear that a man skilled in the art may make several variations and changes to the mounting system for a device, such as a television screen, a monitor, a CRT monitor, an LCD monitor, a flat screen and the like according to the present invention in order to meet specific and incidental needs, all falling within the scope of protection defined in the following claims.

1-52. (canceled)

53. A mounting system or support structure for a device such as a household appliance, a monitor, a television screen, a flat screen, the mounting system being suitable for allowing a predetermined oscillation of the device about an axis, the axis passing through the mounting system, for the positioning in one of a plurality of predetermined balance positions of the device, the mounting system comprising:
at least one mounting structure or support element suitable for integrally connecting the device to the mounting system in a selectively removable manner;
at least one mounting support or anchoring element for integrally fixing the mounting system to a support interface in a selectively removable manner, the support being pivoted along the axis to the mounting structure so that the mounting structure is tilting relative to the support by an oscillation about the axis;
the support element and anchoring element are two portions;
wherein at least one of the two portions comprises coupling means comprising at least one guide or engagement portion suitable for allowing the oscillation of the mounting structure about the axis wherein the engagement portion defines at least two engagement grooves for a locking element supported by the other portion of the mounting system, along a first relative moving direction between the two portions about the oscillation axis, the locking element being suitable for engaging in a sequence in a steady manner the at least two engagement grooves while along the other relative moving direction the locking element being suitable for moving in disengagement along the engagement portion relative to the at least two engagement grooves,
wherein the locking element comprises a pin element exhibiting a first engagement element slidingly associated to the at least one engagement portion defined on one of the two portions and a second engagement element slidingly supported by a lock-release portion defined on the other portion of the mounting system and arranged substantially facing the engagement portion.

54. A mounting system according to claim 53, wherein the anchoring element is fixable, by first fixing means, to a structural element and the support element is fixable, by second fixing means, to an object to be supported.

55. A mounting system according to claim 53, wherein the at least one engagement portion extends along a circumference portion centred at the oscillation axis.

56. A mounting system according to claim 53, wherein the at least one engagement portion comprises a respective sliding portion.

57. A mounting system according to claim 53, wherein the sliding portion during use is arranged on top of the at least two engagement grooves.

58. A mounting system according to claim 53, wherein the lock-release portion is shaped as an upturned V, the upturned V exhibits a bottom end substantially extending up to the height of the at least two engagement grooves and the other bottom end extending up to the height of the disengagement portion.

59. A mounting system according to claim 53, wherein each of the two portions comprises a pair of shoulders, on each shoulder there being defined, respectively, the at least one engagement portion and at least one lock-release portion.

60. A mounting system according to claim 53, wherein at one of the two portions there are provided two engagement portions, each defining at least two engagement grooves for a respective locking element supported by the other portion of the mounting system, along a first relative moving direction between the two portions about the oscillation axis the locking element being suitable for engaging, alternately, in a sequence in a steady manner an engagement groove of the two engagement portions.

61. A mounting system according to claim 53, comprising:
at least one mounting structure suitable for integrally connecting the device to the mounting system in a selectively removable manner and comprising:
at least first coupling means that allow an oscillation of the mounting structure about an axis;
at least second coupling means that determine a plurality of predetermined positions;
the mounting system further comprising:
at least one mounting support for integrally fixing the mounting system to a support interface, in a selectively removable manner and comprising:
at least first coupling counter-means suitable for cooperating with the first coupling means for coupling the support to the mounting structure and for allowing the oscillation of the mounting structure;
at least second coupling counter-means suitable for cooperating with the second coupling means for selectively defining a predetermined angular position of the mounting structure relative to the support.

62. A mounting system according to claim 53, wherein the support comprises at least second coupling counter-means suitable for cooperating with the guide for selectively defining a predetermined angular position of the mounting structure relative to the support, for obtaining one of the plurality of predetermined balance positions of the device.

63. A mounting system according to claim 53, wherein the first coupling means comprise first through holes.

64. A mounting system according to claim 53, wherein the second coupling means comprise a plurality of balance seats.

65. A mounting system according to claim 53, wherein the first coupling counter-means comprise at least second through holes and at least one rotation element.

66. A mounting system according to claim 53, wherein the second coupling counter-means comprise at least one positioning element seats.

67. A mounting system according to claim 53, wherein the mounting structure comprises the plurality of balance seats and wherein the mounting structure and the support are connected so as to allow the oscillation about the axis for defining the angular position of the mounting structure relative to the support, wherein, moreover, the mounting structure can be selectively positioned in a plurality of relative predetermined angular balance positions between the mounting structure and the support and wherein each of the plurality of angular balance positions is obtainable by the positioning element which selectively engages in at least one of the balance seats.

68. A mounting system according to claim 53, wherein the positioning element is a positioning seat.

69. A mounting system according to claim 53, wherein the mounting structure exhibits two side plates, each exhibiting a slot wherein there is obtained the plurality of seats, which limits the oscillation of the mounting structure relative to the support.

70. A mounting system according to claim 53, wherein the slot defines a restricted and predetermined succession of the seats.

71. A mounting system according to claim 53, wherein the side plates are connected by a hooking plate suitable for associating to the device for the tilting thereof.

72. A mounting system according to claim 53, wherein each of the seats is suitable for seating the positioning pin for defining a balance position between the mounting structure and the support.

73. A mounting system according to claim 53, wherein the positioning pin has a substantially elongated section, the positioning pin exhibiting at least one flat face.

74. A mounting system according to claim 53, wherein the positioning pin has a substantially oval section, exhibiting two opposite flat faces.

75. A mounting system according to claim 53, wherein the positioning pin has a substantially elliptical section.

76. A mounting system according to claim 53, wherein each of the seats has a shape suitable for geometrically coupling with the positioning pin.

77. A mounting system according to claim 53, wherein each of the seats has a shape substantially at least partly ellipsoidal or oval, so as to geometrically couple with the positioning pin with elliptical or oval section.

78. A mounting system according to claim 53, wherein the rotation element is a rotation pin that defines the rotation axis about which the mounting structure can relative to the support.

79. A mounting system according to claim 53, wherein the support exhibits two side wings connected by a spacer plate.

80. A mounting system according to claim 53, wherein the support is seated between the side plates.

81. A mounting system according to claim 53, wherein the support is coupled to the mounting structure by the rotation pin.

82. A mounting system according to claim 53, wherein the rotation pin is seated in the first through holes obtained on the side plates and in second through holes obtained on the side wings and screwed by bolt means.

83. A mounting system according to claim 53, wherein the rotation pin and the positioning pin extend transversally relative to the mounting structure and to the support, passing respectively inside the first through holes and the second through holes.

84. A mounting system according to claim 53, wherein the seats are defined by tips jointed to each other.

85. A mounting system according to claim 53, wherein the tips exhibit a substantially smooth and chamfered profile for allowing the sliding by rolling of the positioning pin.

86. A mounting system according to claim 53, wherein the mounting structure is in steady position relative to the support when the positioning pin is fully seated in one of the seats and is in unsteady position when the positioning pin is not seated in one of the seats.

87. A mounting system according to claim 53, wherein the positioning pin rotates about an axis thereof and at the same time, moves from the steady position following the perimeter of the slot to move from a first seat to an adjacent seat and wherein moreover, at the same time the mounting structure rotates relative to the support about the axis.

88. A mounting system according to claim 53, wherein the section of the positioning pin has a larger dimension suitable for being seated between two facing of the seats and a smaller dimension suitable for allowing the passage of the positioning pin between two facing of the tips in the slot.

89. A mounting system according to claim 53, wherein the positioning pin passes from the steady position to the unsteady position and vice versa by a rotation of about 90° about the axis thereof, thanks to the fact that the smaller dimension is suitable for allowing the passage of the positioning pin between two facing of the tips in the slot.

90. A mounting system according to claim 53, wherein the passage of the positioning pin from a first seat to an adjacent seat defines a passage from the first steady relative position to a further steady relative position of the mounting structure relative to the support.

91. A mounting system according to claim 53, wherein the steady relative position is a tilted position of the mounting structure relative to the support.

92. A mounting system according to claim 53, wherein the angular position of the mounting structure defines an angle comprised in a range between 0° and 20°.

93. A mounting system according to claim 53, wherein the positioning element can be manoeuvred by a gripping means such as a knob or a lever, suitable for providing a twisting torque to the positioning element.

94. A mounting system according to claim 53, wherein each of the wings exhibits at a first end a hook for the sliding hooking to a top rail of the support interface.

95. A mounting system according to claim 53, wherein each of the wings exhibits at a second end a flange system for the sliding association to a bottom rail of the support interface.

96. A mounting system according to claim 53, wherein the hooking plate exhibits hooking holes for hooking the mounting structure to the device.

97. A mounting system according to claim 53, comprising the support interface.

98. A mounting system according to claim 53, comprising the device.

99. A mounting system according to claim 53, wherein the support interface exhibits mounting apertures for integrally connecting in a selectively removable manner the support interface to a flat surface, such as a vertical and/or horizontal flat surface, a wall, a wall, a partition and the like.

100. A device, such as a television screen, a monitor, a CRT monitor, an LCD monitor, a flat screen and the like, integrally connected in a selectively removable manner to a mounting system according to claim 53.

101. A mounting system for a device, such as a television screen, a monitor, a CRT monitor, an LCD monitor, a flat screen and the like, comprising:
at least one mounting structure suitable for integrally connecting the device to the mounting system in a selectively removable manner and comprising:
at least first coupling means that allow an oscillation of the mounting structure about an axis;
the axis passing through the mounting system,
at least second coupling means that determine a plurality of predetermined positions;
the mounting system further comprising:
at least one mounting support for integrally fixing the mounting system to a support interface, in a selectively removable manner and comprising:
at least first coupling counter-means suitable for cooperating with the first coupling means for coupling the support to the mounting structure and for allowing the oscillation of the mounting structure;
at least second coupling counter-means suitable for cooperating with the second coupling means for selectively defining a predetermined angular position of the mounting structure relative to the support,
wherein the at least first coupling means comprises an arched groove or a circular groove for spatially restricts the oscillation of the mounting structure relative to the support;
the arched groove or circular groove defines a restricted and predetermined succession of seats for the second coupling counter-means.
